(19) United States
(12) Patent Application Publication
(10) Pub. No.: US 2024/0078849 A1
(43) Pub. Date: Mar. 7, 2024

(54) WIRELESS USER INTERFACE WITH BACKUP BATTERY SUPPORT OPERATING IN LOW POWER MODE

(71) Applicant: GM GLOBAL TECHNOLOGY OPERATIONS LLC, Detroit, MI (US)

(72) Inventors: Alex J. Veloso, Rochester Hills, MI (US); Dipankar Pal, Sylvania, OH (US); Eric T. Hosey, Royal Oak, MI (US); Russell A Patenaude, Macomb Township, MI (US); Andrew J. MacDonald, Grosse Pointe Park, MI (US); Matthew E. Gilbert-Eyres, Rochester Hills, MI (US)

(73) Assignee: GM GLOBAL TECHNOLOGY OPERATIONS LLC, Detroit, MI (US)

(21) Appl. No.: 17/902,341

(22) Filed: Sep. 2, 2022

(51) Int. Cl. G07C 5/00; G06F 3/04817; G06F 3/0482; G06F 3/0488

(52) U.S. Cl. CPC G07C 5/008; G06F 3/04817; G06F 3/0482; G06F 3/0488; B60R 16/03

(57) ABSTRACT

A system includes a main power unit providing power, user interfaces providing an indication of an event requiring communication with an external location, a telematics system providing communications related to telematics services, and a communication interface initiating communication between a vehicle and the location in response to the indication. The system also includes a wireless communication unit facilitating communication between the user interfaces and the communication interface and between the communication interface and the location, a first back-up power unit supplying power such that a touchscreen interface remains functional during disruption of power supplied, a second back-up power unit supplying power such that the user interfaces and wireless communication unit remain functional during disruption of power, and a control processor sensing a disruption of power and activating a low-power operating mode for the user interfaces and wireless communication unit when disruption of power is sensed.

### INTRODUCTION

The present disclosure is related generally to motor vehicle-based telematics systems and more specifically to using such telematics systems within vehicles to establish a call directed to a supported telematics system service, such as for navigation assistance or a service request.

Telematics Units (TUs) within mobile vehicles provide users with connectivity to a telematics service provider (TSP). The TSP, in turn, provides connected subscribers or users with an array of services ranging from event call handling and stolen vehicle recovery to diagnostics monitoring and turn-by-turn navigation. Upon activation, the TU provides a user with a wide variety of telematics services rendered by a variety of networked TSPs.

Presently, communication connections for TSPs are initiated by a user selecting a corresponding one of multiple physical hardware pushbuttons mounted in a vicinity of a driver of a vehicle. Given the importance of the TU remaining available when the primary vehicle power is disrupted, a back-up power source or back-up battery (BUB) may be provided for supplying power to the TU upon disruption of primary vehicle power, including the hardware pushbuttons and associated telematics audio input/output (I/O) equipment.

As an alternative to dedicated hardware pushbuttons, a combined telematics touchscreen (TS) interface may present soft buttons, such as icons, via which communication with TSPs may be initiated. The icons may be presented on any current telematics TS display. Similar to pushbuttons, a continuous power source, such as a BUB is provided to ensure continued operation of icons, and associated communication hardware and telematics audio and video I/O equipment, when main power provided by a primary power source is disrupted.

Incorporating the dedicated hardware pushbuttons as TS icons maintains required features of existing physical pushbuttons incorporated into physically separate consoles. Replacing the dedicated pushbuttons as TS icons reduces hardware costs, avoids additional clutter in the center console of a vehicle, and provides a place to locate the dedicated pushbuttons in vehicles without an overhead console.

Providers of telematics systems face a challenge of ensuring continuous, easy, non-obtrusive user access to the previously disclosed pushbuttons and icons. The present disclosure addresses this challenge, as well as other issues.

### SUMMARY

The present disclosure provides a system for initiating a telematics service call via a touch-based user interface. The system includes a main power unit, one or more user interfaces (UI), a telematics system, a communication interface, an electrical control, a first back-up power unit, a second back-up power unit, and a control processor. The main power unit provides power to operate the vehicle and a plurality of vehicle systems. The one or more user interfaces facilitate a user providing an indication of an event that requires communication with a location external the vehicle. The telematics system provides communications related to telematics services. The communication interface initiates communication between the vehicle and the location external the vehicle in response to receiving the indication of the event. The wireless communication unit facilitates communication, in the absence of a serial communications network and ethernet signals, between the one or more user interfaces and the communication interface and between the communication interface and the location external the vehicle. The first back-up power unit supplies power to a touchscreen interface such that the touchscreen interface remains functional during disruption of power supplied by the main power uni. The second back-up power unit supplies power to the user interface and the wireless communication unit such that the user interface and wireless communication unit remain functional during disruption of power supplied by the main power unit. The control processor senses a disruption of power provided by the main power unit and activates a low-power operating mode for the user interface and wireless communication unit when disruption of power provided by the main power unit is sensed.

The system may further include a plurality of user interfaces located at various locations of the vehicle, each of the plurality of user interfaces providing an indication of an event that requires communication with the location external the vehicle, where the communication interface further initiates communication between the vehicle and the location external the vehicle in response to receiving the indication from any of the plurality of user interfaces. The wireless communication unit further facilitates communication, in the absence of the serial communication interface and the ethernet signals, between each of the plurality of user interfaces and the communication interface.

At least one of the plurality of user interfaces may be located external an area of the vehicle in which a driver of the vehicle is located when the vehicle is in motion. The wireless communication unit may further determine if the indication is received from the at least one of the plurality of user interfaces located external the area of the vehicle in which a driver of the vehicle is located.

The wireless communication unit may further facilitate communication between at least one of the plurality of user interfaces and at least one device or software application installed in the vehicle after purchase. The at least one device or software application may be related to a camera.

The control processor may further provide power to operate the wireless communication unit and detect and provide a corresponding indication that the main power unit is not operational. At least one of the one or more user interfaces may include a pushbutton.

The location external the vehicle may include a call center with at least one operator. The wireless communication unit may include a Bluetooth Low Energy unit.

The main power unit may include a battery. The second back-up power unit may include a battery.

The serial communications network may include a Controller Area Network. The system may further include a microphone and a speaker providing bi-directional audio communications with providers of telematics services.

The system may further include a touchscreen user interface that facilitates initiation of the telematics service call via one or more user-selectable graphical touch-screen soft buttons. Each of the one or more user interfaces may include pushbuttons or icons.

The previous summary is not intended to represent every embodiment or every aspect of the present disclosure. Rather, the summary merely provides an exemplification of some of the novel concepts and features disclosed herein. The previous features and advantages, and other features and advantages, will be readily apparent from the following detailed disclosure of embodiments and representative modes for carrying out the disclosure when taken in connection with the accompanying drawings and appended claims. Moreover, this disclosure expressly includes any and all combinations and sub-combinations of the elements and features disclosed herein.

### BRIEF DESCRIPTION OF THE DRAWINGS

FIG. 1 illustrates an operating environment for a mobile vehicle communication system according to an embodiment of the present disclosure.

FIG. 2 illustrates a backup power supply scheme for implementation of a telematics service request interface according to an embodiment of the present disclosure.

FIGS. 3A-3D illustrate touch screen display interfaces in various modes of operation according to an embodiment of the present disclosure.

FIG. 4 illustrates an electrical control unit according to an embodiment of the present disclosure.

FIGS. 5A and 5B illustrate a comparison of an electrical control unit of present systems and an electrical control unit according to an embodiment of the present disclosure.

FIG. 6 illustrates support of after-market phone applications according to an embodiment of the present disclosure.

The present disclosure may be extended to modifications and alternative forms, with representative embodiments shown by way of example in the drawings and described in detail subsequently. Inventive aspects of the disclosure are not limited to the disclosed embodiments. Rather, the present disclosure is intended to cover modifications, equivalents, combinations, and alternatives falling within the scope of the disclosure as defined by the appended claims.

### DETAILED DESCRIPTION

The present disclosure may be embodied in many different forms. Representative embodiments of the present disclosure are illustrated in the drawings and disclosed herein in detail as non-limiting examples. Disclosure not explicitly recited in the claims, should not be incorporated into the claims, singly or collectively, by implication, inference, or otherwise.

For purposes of the present disclosure, unless specifically disclaimed, use of singular tense includes the plural tense and vice-versa, the terms “and” and “or” shall be both conjunctive and disjunctive, and the words “including,” “containing,” “comprising,” “having,” and similar terms shall mean “including without limitation.” Moreover, words of approximation such as “about,” “almost,” “substantially,” “generally,” “approximately,” and similar words may be used herein in to mean “at, near, or nearly at,” or “within 0-5% of,” or “within acceptable manufacturing tolerances,” or logical combinations thereof.

A component disclosed as “configured to perform or “configured for performing” a specified function is capable of performing the specified function without alteration, rather than merely having potential to perform the specified function after further modification. In other words, the disclosed hardware, when expressly “configured to perform or “configured for performing” the specified function, is specifically selected, created, implemented, utilized, programmed, and/or designed for performing the specified function. In the drawings, like reference numbers refer to the same or similar components.

The terms “controller,” “processor,” “control unit” and “control module” used herein refers to one or more Application Specific Integrated Circuit(s) (“ASIC”), Field-Programmable Gate Array (“FPGA”), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), I/O circuit(s) and devices, signal conditioning and buffer circuitry and other components that may be accessed by one or more processors to provide a described functionality.

Communication between a controller and individual control modules of a vehicle not specifically disclosed herein, and associated hardware and software, may be accomplished via direct wired point-to-point link, a networked communication bus link, a wireless link or another suitable communication link. Communication may include exchanging data signals in suitable form, including transmitting electrical signals or electromagnetic signals over a conductive medium via air as a transmission medium, transmitting optical signals via optical waveguides, and the like. Data signals may include discrete, analog or digitized analog signals representing inputs from sensors, actuator commands, and communication between controllers.

The term “signal” as used herein refers to a physically discernible indicator that conveys information, and may be a suitable waveform (e.g., electrical, optical, magnetic, mechanical or electromagnetic), such as direct current (“DC”), alternating current (“AC”), sinusoidal-wave, triangular-wave, square-wave, vibration, and the like, which is capable of traveling through a medium.

The term “parameter” as used herein is a measurable quantity that represents a physical property of a device or other element, and that is discernible using one or more sensors and/or a physical model. A parameter may have a discrete value, such as “1” or “0,” or may have a value that is variable.

Prior to discussing details of the present disclosure and the environment wherein the present disclosure may be utilized, a brief overview of an exemplary networked telematics system is provided. In general terms, not intended to limit the appended claims, the present disclosure is directed to, such as a telematics system display interface that presents selectable telematics service connection initiation icons that are presented as a temporary overlay on a current telematics services TS display.

A continuous power supply is maintained when power provided by a primary power source (PPS) to the telematics system is disrupted. A backup power source, such as a Back-Up Battery (BUB), provides power to at least specific components of the processing and I/O interface components, including the telematics system, needed to present selectable services. Such specific components include audio I/O hardware, such as a microphone and speaker, associated with vehicle services during an event, mobile wireless communications components, and at least a portion of the telematics system interface presenting user-selectable icons, where at least one of the user-selectable icons is selectable to cause the TU to create a service request communication connection.

The system of the present disclosure includes a telematics component configured to present a set of telematics service call icons that are selectable by users to establish communication for requesting corresponding telematics services, such as navigation and calls related to an event, from a TSP. The system further includes at least two BUBs and corresponding power management control (PMC). The PMC selectively provides power to specific components while the at least two BUBS supply power for the telematics system.

The telematics service icons may be hidden from view in a default operational state of the telematics system and presented for activation in response to a user touching a designated part of the TS. Therefore, the telematics service icons, while generally hidden, may be presented for selection on the telematics system by touching, for example, a designated “telematics services” icon of a default operation screen of the telematics system interface.

An exemplary computing and network communications environment is disclosed subsequently. The disclosed environment is an illustrative example and does not imply a limitation regarding the use of other environments to practice the present disclosure.

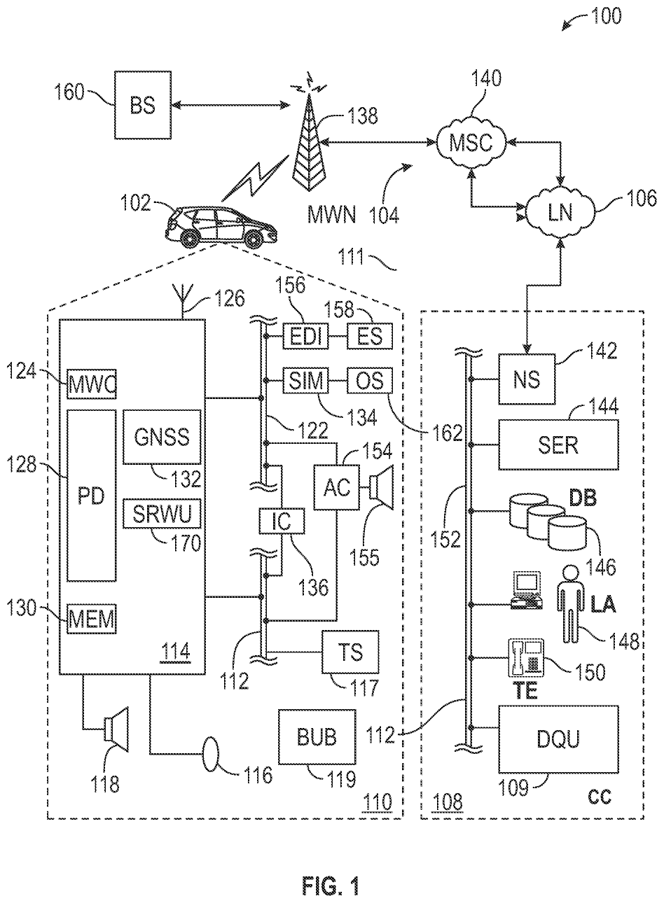

FIG. 1 illustrates an operating environment for a mobile vehicle communication system according to an embodiment of the present disclosure. As illustrated in FIG. 1, a communication system 100 generally includes a vehicle 102, a mobile wireless network (MWN) 104, a land network (LN) 106 and a communications center (CC) 108.

The general overall architecture, setup and operation of the various networked components of the communication system 100 are generally understood and will not be described herein. Rather, the present disclosure primarily focuses on the re-configuration of existing architecture of the communication system 100, specifically components of a telematics unit (TU) 114 to present selectable telematics service request pushbuttons or icons that are displayed on a graphical display device, such as a TS 117, including TS interface functionality. The CC 108 includes a database and query unit (DQU) 109, which incorporates functional components configured to manage a plurality of records, such as fields related to vehicles, vehicle occupants (drivers or passengers), or roads.

The vehicle 102 may be a motorized vessel, such as a motorcycle, a car, a truck, or a recreational vehicle (RV). The vehicle 102 is equipped with hardware and software that configures or adapts the vehicle 102 to facilitate communications with the CC 108 via mobile wireless communications. The vehicle 102 includes hardware 110, such as a TU 114, a microphone 116, a speaker 118 for performing two-way (interactive) audio communication with a TSP, and the TS 117 or a speaker 155 driven by an audio component (AC) 154.

The speaker 118 is utilized to issue an audible warning or alert to a user when a notification is received from the CC 108 via the communications system 100. The use of the speaker 118 to issue notifications may potentially reduce the need for a user to view a display, such as TS 117 coupled to an audio-video (AV) bus 112, to obtain warnings or alerts.

The TU 114 is coupled, via a hard wire connection and/or a wireless connection, to a vehicle bus 122 for supporting communications between electronic components within the vehicle 102. Examples of suitable network technologies for implementing the vehicle bus 122 include a Controller Area Network (CAN), a Media-Oriented System Transfer (MOST), a local interconnection network (LIN), an Ethernet, and other connections that conform with understood International Organization for standardization (ISO), Society of Automotive Engineers (SAE), and Institute of Electrical and Electronics Engineers (IEEE) standards and specifications.

The TU 114 is a highly configurable or programmable on-board electronic device providing a variety of services via execution of program instructions and communications with networked system components including the CC 108. The TU 114 includes an electronic Processing Device (PD) 128, such as a processor, Memory (MEM) 130, a Mobile Wireless Component (MWC) 124 including a mobile wireless chipset, a dual function antenna 126, both Global Navigation Satellite System GNSS and mobile wireless signals, which may be internal or external to TU 114, and a GNSS component 132 including a GNSS chipset.

In one embodiment of the present disclosure, the MWC 124 is an electronic memory storing a set of computer-executable instruction sets/routines that are transferred to, and executed by, the PD 128. The MWC 124 is a network access device (NAD) component of the TU 114. The NAD operates to modulate one or more carrier wave signals in order to encode digital information for transmission via the MWN 104 and demodulate signals received from the MWN 104 to decode and render a digital version of the received information.

The TU 114 provides an expandable set of services for users. Examples of the provided services include concierge services, GNSS-based services including mapping or location identification, turn-by-turn directions, advanced warning for restricted areas and other navigation-related services provided in conjunction with the GNSS component 132, and airbag deployment notification and other event or roadside assistance-related services provided in connection with various sensor interfaces and sensors located throughout the vehicle 102. The TU 114 also supports receiving and forwarding a variety of sensor readings related to operation of the vehicle 102.

The TU 114 further includes a Short-Range Wireless Unit (SRWU) 170 capable of communicating with a user's Mobile Wireless Device (MWD), such as a cellular phone, tablet computer, or personal digital assistant (PDA) utilizing an SRW protocol. For example, the SRWU 170 may be a Bluetooth (BT) unit with a radio frequency (RF) transceiver that communicates with a vehicle occupant's MWD by utilizing a BT protocol. Other short-range wireless communication technologies may be utilized.

The information provided by the MWD to the TU 114 via the SRWU 170 may be provided to the DQU 109 that is configured to maintain registered user information. The TU 114 also supports infotainment-related services whereby music, Web pages, movies, television programs, video games and/or other content is downloaded under control/command of an infotainment center (IC) 136 operatively connected to the TU 114 via the vehicle bus 122 and the AV bus 112.

The previously disclosed services are by no means an exhaustive list of the current and potential capabilities of the TU 114, as should be appreciated by those skilled in the art, but rather are merely a small subset of the services that the TU 114 is capable of providing to users. Furthermore, the TU 114 includes a number of components in addition to those previously disclosed but these components have been excluded from the present disclosure since they are not required to understand the functionality of the present disclosure.

The TU 114 uses radio transmissions to establish communications channels with the MWN system 104 such that voice and data signals may be transmitted and received via communication channels. The MWC 124 enables both voice and data communications via the MWN system 104 and applies encoding or modulation functions or technologies to convert voice and/or digital data into a signal transmitted via the antenna 126.

A suitable encoding or modulation function that provides an acceptable data rate and bit error may be utilized. The antenna 126 processes signals for both the MWC 124 and the GNSS component 132.

The microphone 116 provides a user with an interface for inputting verbal or other auditory commands to the TU 114 and may include an embedded voice processing unit utilizing a human/machine interface (HMI) technology. The speaker 118 provides verbal output to the vehicle occupants and may be either a stand-alone speaker specifically dedicated for use with the TU 114 or part of the AC 154. The microphone 116 and the speaker 118 enable the hardware 110 and the CC 108 to communicate with occupants of the vehicle 102 via audible speech.

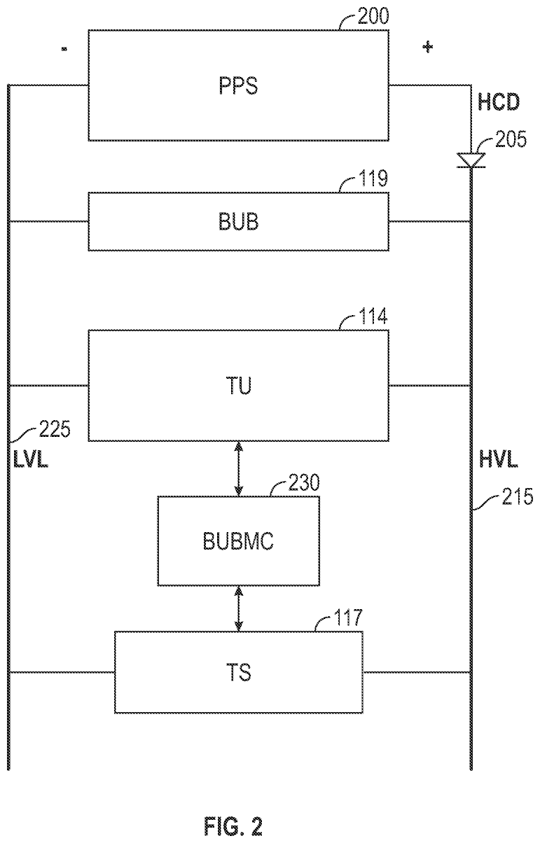

The hardware 110 also includes at least two BUBS 119 that may be internal or external to the TU 114. The BUB 119 provides temporary power to critical components of the TU 114 and related communication and I/O components required to provide telematics services in the event of main power (primary battery and/or alternator) disruption. An exemplary arrangement of the connection of the at least two BUBS 119 to the TS 117 and TU 114 is illustrated in FIG. 2.

Icons allow a user to request telematics services via the TS 117, such as voice communication with the CC 108 or event-related services facilitated by the TU 114. The AC 154 is connected to the vehicle bus 122 and the AV bus 112. The AC 154 receives analog information via the AV bus 112 and provides the analog information as sound.

The AC 154 receives digital information via the vehicle bus 122. The AC 154 provides radio and multimedia functionality, such as Universal Serial Bus (USB), Secure Digital (SD) Card, BT, Compact Disc (CD), Digital Video Disc (DVD), and Blue Ray, independent of the IC 136. The AC 154 may include the speaker 155 or may utilize the speaker 118 via communication on the vehicle bus 122 and/or the AV bus 112.

An Event Detection Interface (EDI) 156 is connected to the vehicle bus 122. Event Sensors (ES) 158 provide information related to a vehicle event, such as a corresponding angle or amount of force, to the TU 114 via the EDI 156.

Other Sensors (OS) 162 are connected to corresponding Sensor Interface Modules (SIM) 134, which are connected to the vehicle bus 122. Examples of the OS 162 include a short-range wireless sensor, gyroscopes, accelerometers, magnetometers, fuel level sensors, and coolant temperature sensors.

Examples of the SIM 134 and EDI 156 include modules for power control, climate control, and vehicle body control. Data from the SIM 134 and EDI 156 is provided to automobile electronic control units, including an engine control unit, body control module (BCM), electronic brake system module (EBCM), and other electronics vehicle modules (not illustrated in FIG. 1).

The MWN system 104 may be a cellular telephone network system or other suitable mobile wireless system that transmits signals between mobile wireless devices, such as the TU 114 and LN 106. As illustrated in FIG. 1, the MWN system 104 includes cell towers 138, base stations (BS) 160, and mobile switching centers (MSCs) 140, as well as other networking components facilitating or supporting communication between the MWN system 104 and the LN 106. The MWN system 104 includes various cell tower 138/BS 160/MSC 140 arrangements. For example, a BS 160 and a cell tower 138 could be co-located at the same site, or they could be remotely located, with a single BS 160 coupled to various cell towers 138 or various BSs 160 coupled with a single MSC 140.

The LN 106 may be a conventional land-based telecommunications network that is connected to one or more landline end node devices, such as telephones, and connects the MWN system 104 to the CC 108. For example, the LN 106 may include a public switched telephone network (PSTN) and/or an Internet protocol (IP) network. One or more segments of the LN 106 may be implemented as a standard wired network, a fiber or other optical network, a cable network, or other wireless networks such as wireless local networks (WLANs) or networks providing broadband wireless access (BWA), or combination thereof.

The CC 108 provides a variety of services and application functionality to the hardware 110. The CC 108 may include Network Switches (NS) 142, servers (SER) 144, databases (DB) 146, Live Advisors (LA) 148, as well as a variety of other Telecommunications Equipment (TE) 150, such as modems and computer/communications equipment. The various components of the CC 108 may be coupled to each other via a network link 152, such as a physical Local Area Network (LAN) bus or a wireless local network.

The network switches 142, such as a Private Branch Exchange (PBX) switch, route received signals such that voice transmissions are provided to either the LA 148 or an automated response system, with data transmissions provided to a modem or other component of the TE 150 for processing, such as demodulation and further signal processing.

The TE 150 may include an encoder and be connected to various devices such as the SER 144 and the DB 146. The DB 146 includes computer hardware and stored programs configured to store pertinent user information.

Although the CC 108 is illustrated in FIG. 1 as a manned CC, the CC 108 may be one of a variety of central or remote facilities that are manned or unmanned or mobile or fixed facilities, with which it is desirable to exchange voice and data.

Execution of the various machine-implemented processes and steps of the present disclosure may occur via computerized execution of computer-executable instructions stored on a tangible computer-readable medium, such as Random Access Memory (RAM), Read Only Memory (ROM), Programmable Read-Only Memory (PROM), volatile, nonvolatile, or other electronic memory. Therefore, operations may be performed by the PD 128 of the TU 114 according to instructions or applications of the TU 114 that are stored in the MEM 130 and operations may be performed by the CC 108 according to stored instructions or applications of the CC 108.

However, present systems have challenges. The present disclosure addresses these challenges by expanding the functions of physical pushbuttons and icons and maximizing safety operations.

One challenge of present systems are situations that prevent a user from initiating a call for service from the CC 108, specifically the TU 114 is not operational when the hard-wired connections are disrupted, when an ignition state of the vehicle 102 is in off, or when a CAN bus that provides an indication of the ignition state is interrupted due to an event.

Another challenge of present systems is that they do not allow expansion of the function of physical push buttons for using additional applications.

Another challenge of present systems is that providing multiple TU 114s requires changing the electrical interface of the TU 114 and the TCU.

Another challenge of present systems is that they do not facilitate utilizing the TU 114 to start an application, such as recording by a camera, when the ignition state of the vehicle 102 is in off.

Another challenge of present systems is the TU 114 cannot be utilized as an alternative to cellular RAT sunset technologies.

Another challenge of present systems is they do not facilitate utilizing the TU 114 with applications not located in the vehicle 102, such as applications on a user's phone.

FIG. 2 illustrates a backup power supply scheme for implementation of a telematics service request interface according to an embodiment of the present disclosure. The backup power supply scheme illustrated in FIG. 2 provides continuous support of telematics service when the TU 114 has lost access to a primary power supply providing power, such as a main battery or alternator, or primary voltage is disrupted.

As illustrated in FIG. 2, a primary power supply (PPS) 200 is provided, which may include a primary battery and an alternator that operate as the primary power source for the electronic components of the vehicle 102 illustrated in FIG. 1. A positive terminal of the PPS 200 is connected to a High-Capacity Diode (HCD) 205 or other power supply control circuit for ensuring that the PPS does not draw power from the at least two BUBS 119. The at least two BUBS 119 are configured to acquire and maintain a charge until needed, such as when the main power supply from the PPS is disrupted.

As further illustrated in FIG. 2, a power bus High Voltage Line (HVL) 215 couples an output from the HCD 205 to the at least two BUBS 119, the TU 114 components and the TS 117. Moreover, as illustrated in FIG. 2, a power bus Low Voltage Line (LVL) 225 couples the PPS 200 low-power terminal, the at least two BUBS 119, the TU 114 components and the TS 117 to a common low (ground) voltage.

The power supply bus configuration illustrated in FIG. 2 is intended to be a representative configuration for providing primary and backup power to components of the TU 114 and the TS 117 that are connected to the TU 114 via the vehicle bus 122 or other direct hardware connection. Alternative primary and backup power supply circuits and schemes are contemplated in alternative embodiments of the present disclosure providing substantially similar functionality to the scheme illustrated in FIG. 2.

With continued reference to FIG. 2, a BUB Mode Controller (BUBMC) 230, which may be external or internal to the TU 114, senses a loss or disruption of power supplied by the PPS 200 by determining a voltage differential across the positive and negative terminals of the PPS 200 or sensing flow of current from a positive terminal of the at least two BUBS 119 connected to the power bus HVL 215. When the BUBMC 230 senses loss or disruption of power supplied by the PPS 200, a power conservation mode signal is issued by the BUBMC 230 to the TU 114 and/or the TS 117 to cause operation of the TS 117 in a power-saving mode such that a portion of a full TS physical visual display and sensor inputs are active.

The active portion of the TS 117 display may present icons for requesting one or more telematics services. Therefore, the icons utilized to request telematics services remain active and functional in the event of PPS 200 disruption.

The at least two BUBS 119 have sufficient energy/power capacity to power the TU 114 and TS 117 in the absence of power from the PPS 200. The TS 117 may be a liquid crystal display (LCD), an Active-Matrix Organic Light Emitting Diode (AMOLED), or an Organic Light-Emitting Diode (OLED) and supports a low-power consumption mode. While operating in the low-power consumption mode, the TS 117 powers a portion of a display interface that produces visible images of the icons.

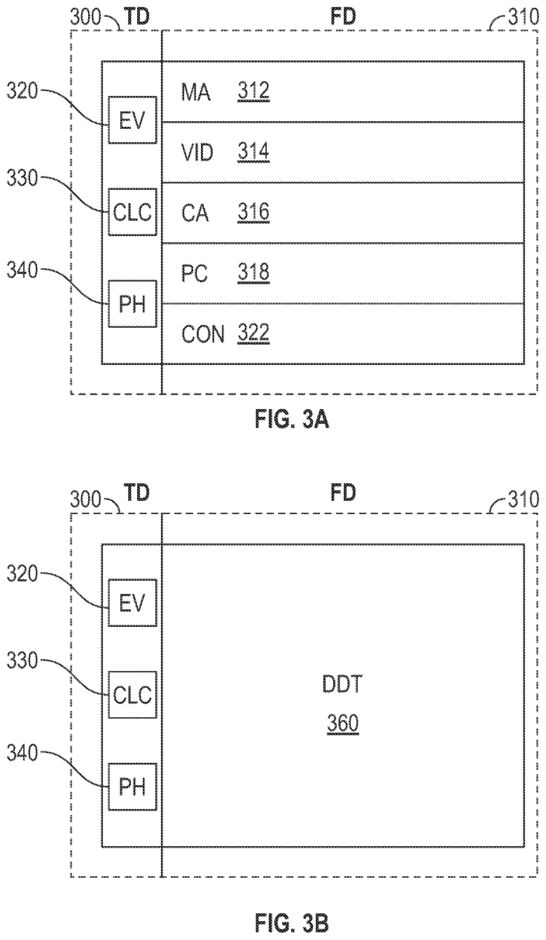

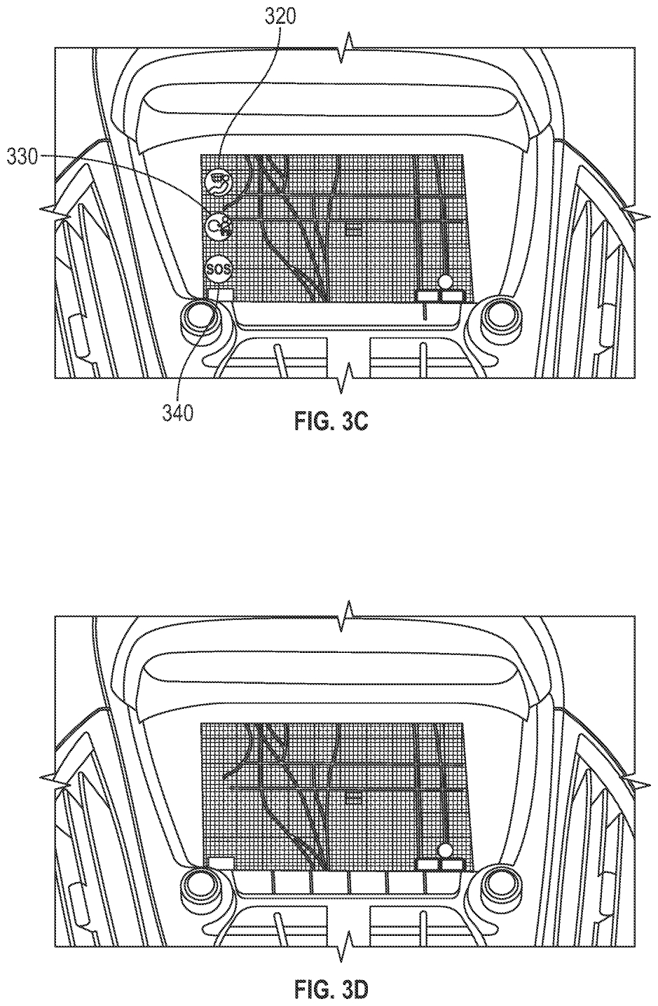

FIGS. 3A-3D illustrate TS display interfaces in various modes of operation according to an embodiment of the present disclosure. FIG. 3A illustrates a home or top-level screen display interface of the TS 117. As illustrated in FIG. 3A, a Telematics Display (TD) segment 300 may include a set of three icons 320, 330 and 340 via which a user initiates a request for a particular telematics service.

The Event (EV) icon 320 initiates an event call when selected. The Call Center (CLC) icon 330 initiates a request for a telematics service call center advisor when selected. The Phone (PH) icon 340 initiates hands-free mobile wireless call functionality when selected. A Function Display (FD) segment 310 may include areas related to various functions associated with the icons 320, 330, 340. Specifically, the FD segment 310 may include a Music/Audio (MA) area 312 related to control of music and audio, a Video (VID) area 314 related to control video, a Call Audio (CA) area 316 related to control of a call, a Phone Control (PC) area 318 via which control of a phone is provided, and a Configuration (CON) area 322.

The specific configuration and shapes of the icons 320, 330, 340 illustrated in FIG. 3A is merely exemplary and other configurations are contemplated for alternative embodiments. The configurations of the icons 320, 330 and 340 illustrated in FIG. 3A is applicable to each of the exemplary interfaces disclosed herein.

FIG. 3B illustrates a power conservation mode of operation that corresponds to the BUB power supply mode of operation of the TU 114 of the TS 117. As illustrated in FIG. 3B, the TD segment 300 remains fully functional. However, the FD segment 310 is disabled with regard to both display and touch sensitivity functionality and a Disabled Display/Touch (DD/T) region 360 is displayed in order to minimize power consumption while the TU 114 is powered by a BUB 119 in a power-conservation mode. The DDT 360, VID 314, CA 316 and CLC 318 areas may still be displayed but not provide selectable functions.

FIGS. 3C and 3D illustrate a child display, such as a satellite radio application display, which occupies an area of the TS 117 including both the TD segment 300 and the FD segment 310 illustrated in FIGS. 3A and 3B. As illustrated in FIG. 3C, a user touch applied anywhere on the TS 117 causes momentary display of the icons 320, 330, 340 as an overlay on the child display screen. The icons 320, 330, 340 are no longer displayed, as illustrated in FIG. 3D when a user touches the TS 117 outside the TD segment 300, such as a portion other than where the icons 320, 330, 340, are located while the TS is in the display mode illustrated in FIG. 3C.

The icons 320, 330, 340 are merely examples of interface controls for presentation of available selections on the TS 117. Other configurations of the child display illustrated in FIG. 3C having alternative graphical user interface selection controls as well as variations in size, shape, image and actuation are contemplated. Therefore, the TS 117 interface may incorporate a type of display or screen technology capable of operating in a low-power mode, such as powering off a portion of the display and dimming the display, whereby the icons 320, 330, 340 remain active while the display itself is operating in an energy-conservation mode.

Additionally, the TU 114 may automatically no longer display the icons 320, 330, 340 that overlay a child screen display that occupies the entire area of the TS 117, as illustrated FIG. 3C, when a delay timer expires. The delay timer may expire a specific time period after the TS 117 initially enters the display mode illustrated in FIG. 3C at which time the display returns to a full application screen display mode, as illustrated in FIG. 3D.

Control of the TU 114 operating in a BUB power supply mode may be performed by selectively deactivating processing hardware and I/O interfaces. The selective deactivation is controlled by software or hardware and/or via function inhibiting logic of programmed power management operations performed by the TU 114.

Present systems control User Interface (UI) signals via hardwire connections to an Electrical Control Unit (ECU) 400, which are susceptible to faults, such as broken or cut wiring, which could prevent a user from utilizing buttons to get assistance from the CC 108. Furthermore, the UI signals of present systems are not operational when vehicle ignition is off since telematics system power is required for Event Service UI (ESUI) signals. Moreover, the architecture of present systems has limitations in allocating multiple UI in parallel.

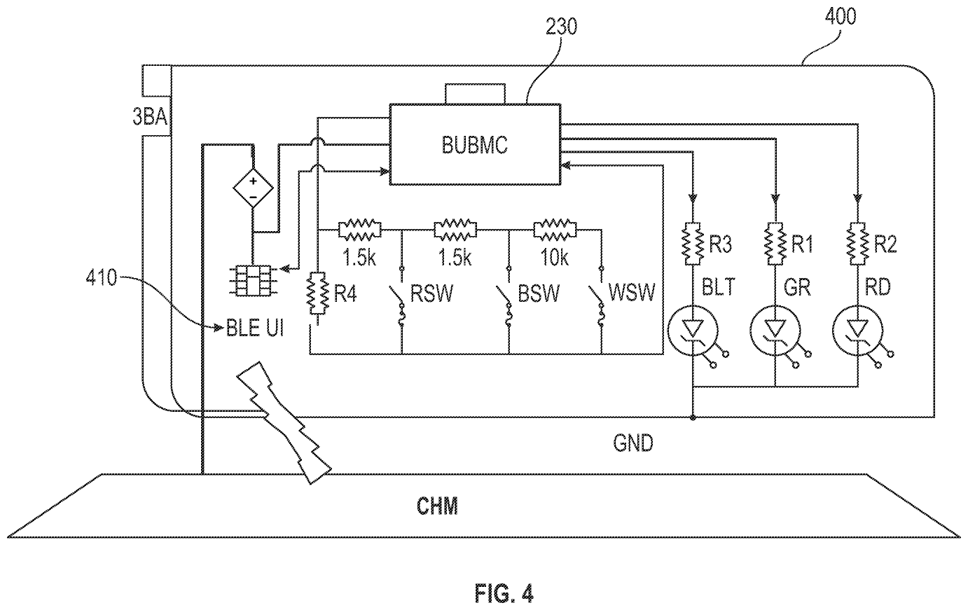

FIG. 4 illustrates an ECU according to an embodiment of the present disclosure. As illustrated in FIG. 4, the ECU includes a UI, such as BT Low Energy (BLE) UI 410 (hereinafter referred to as a “BLE UI”) and the BUBMC 230, a BLE transceiver of a micro controller operating in a low power mode with an interrupter function. The TU 114 will have a BLE transceiver embedded to a controller operating in low power mode.

Whenever the BUBMC 230 senses that an ECU pushbutton or icon was pressed by the user, the interrupter function is initiated, and the ECU will start transmitting via BLE link to the TU 114 which pushbutton or icon was pressed by the user. The TU 114 will receive and identify the pushbutton or icon and execute the associated function, such as a service call or initiating an application, such as initiating camera recording. If the TCU 114 loses primary vehicle power, the BUB 119 installed on TU 114 will provide power the ECU to keep the system operational.

The present disclosure facilitates a UI that wirelessly communicates with an ECU by reducing an amount of hard-wired connections that are susceptible to failure and operating in a reduced power mode of a vehicle IGN-off state. The present disclosure further facilitates providing multiple UIs simultaneously at different locations of the vehicle 102 without changing ECU hardware design. The multiple UIs, which are operable over the BLE link, are powered by the primary vehicle power or BUB 119 such that operation and accessibility is increased.

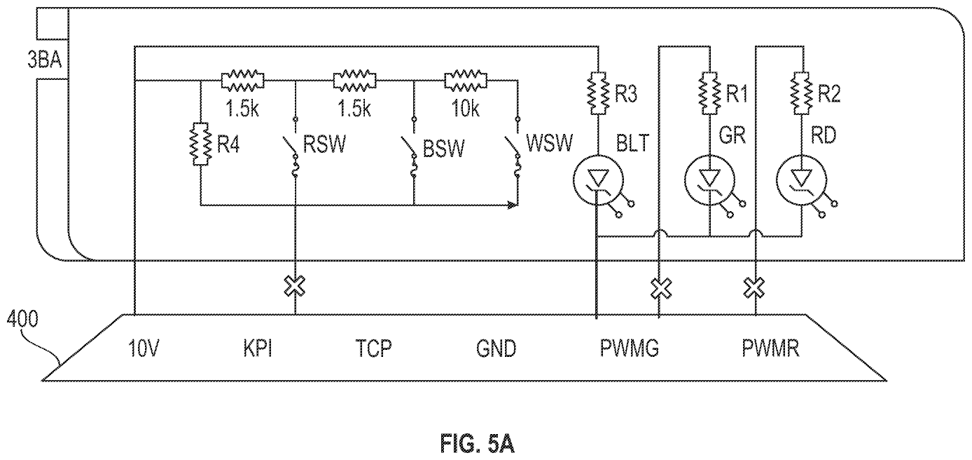

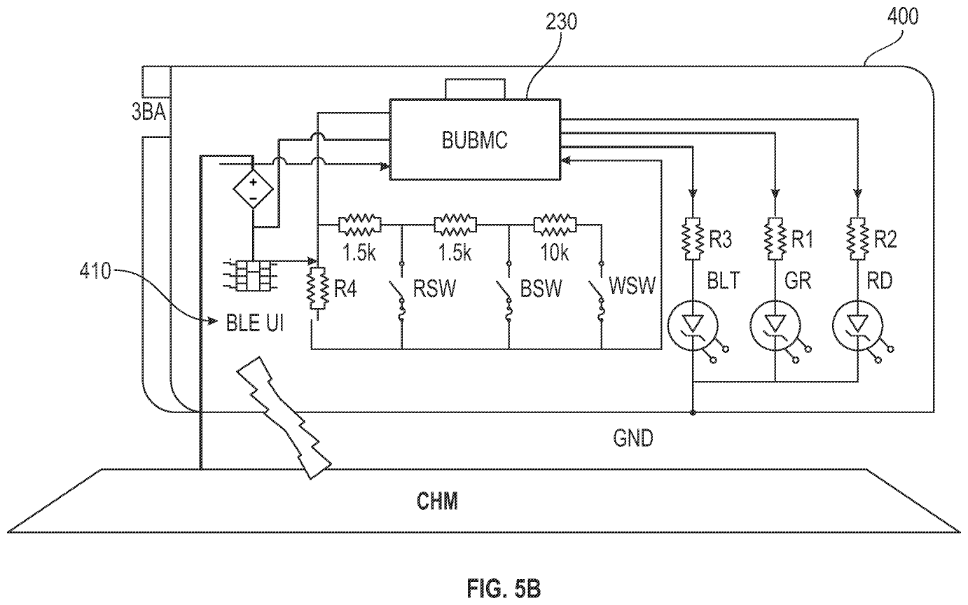

FIGS. 5A and 5B illustrate a comparison of an ECU of present systems and an ECU according to an embodiment of the present disclosure. As illustrated in FIGS. 5A and 5B, instead of utilizing the hard-wired ECU of the present system illustrated in FIG. 5A, the present disclosure establishes wireless communication with the ECU via BT or BLE technology, as illustrated in FIG. 5B. It is noted that an “X” in FIG. 5A indicates connections in a present system, such as a physical wiring assembly for hard-wire control, which are not required in the present disclosure.

The wireless communication of the present disclosure is supported by a separate one of the at least two BUBs 119 than the single BUB of present systems and will allow a user to initiate the ESUI via a wireless button or icon or a BLE UI without requiring the vehicle 102 to be powered, such as when a critical Electrical Vehicle (EV)/InCircuit Emulation (ICE) ECU is missing, the vehicle battery cable is cut, or an Ignition (IGN)-on signal is not present in the CAN. The ECU according to one embodiment of the present disclosure is provided with the BLE UI 410 and BLE UI 410 operating in low-power mode and responsive to a signal from a remote UI that is also equipped with a BLE UI.

A hard-wired TU 114 connection may still be provided to the ECU and BLE UI 410. The hard-wired connection, similar to the hard-wired connection of present systems, would be provided in addition to the BLE wireless link to facilitate detecting an issue, such as loss of hard-wired connection and/or power, as well as other issues, such as an inoperable button or a short, and provide a diagnostics code for display to warn of the degraded condition via wireless communication between the telematics system and the ECU, but also still allow the BLE UI 410 pushbutton device to operate since BLE utilizes low-power mode with the separate one of the at least two BUBs 119 while other pushbuttons may not be operational if they fail to pair/connect.

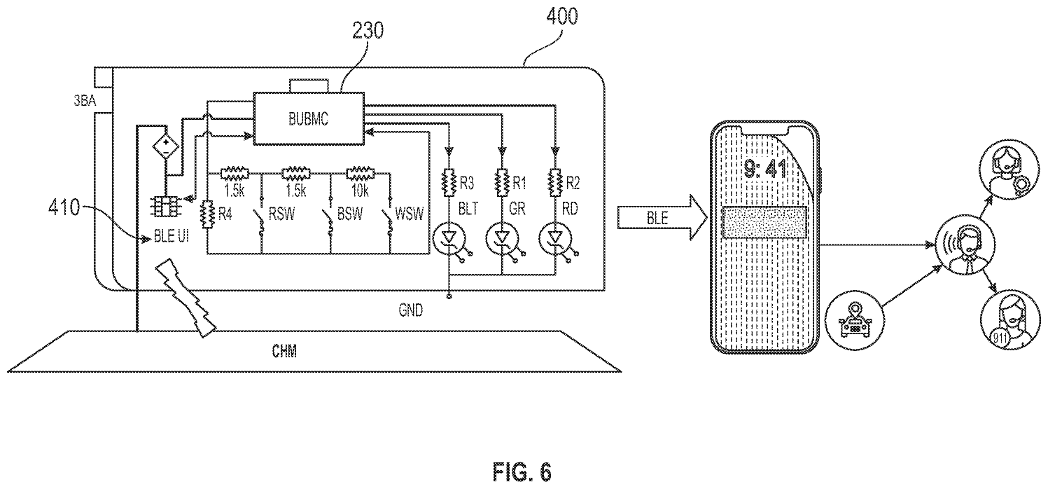

The present disclosure facilitates utilizing after-sales applications as alternatives to utilizing the UI integrated into the vehicle to initiate a service call or to request other service, as illustrated in FIG. 6 in order to adapt to the sunset of a Radio Access Technology (RAT), such as 2G, over time. Since the present telematics system supports 4G cellular services, which will eventually be sunset by cellular carriers, the present telematics system would also effectively be sunset as it could no longer connect to the present cellular network.

The present disclosure also supports after-market phone applications that can connect on a 5G or subsequent network, since the system of the present disclosure can re-pair existing pushbutton assemblies or UIs with a new system in the same manner that interfaces that were paired and connected to the sunset 3G system are now paired to the updated 5G system and continue to operate.

The present disclosure also facilitates connecting other modules and utilizing the UI to control functions of the other modules, such as such as software applications of modules located on a user's phone and related to a camera, via-over-the-air software updates. For example, the function of the UI could be changed to activate and control, via the BLE UI 410 interface, a camera module to record images.

In one embodiment of the present disclosure, a pushbutton or icon of a UI that controls the telematics system by presenting a menu on a display may be paired with the telematics system via BT/BLE and simultaneously paired with a camera module or, alternately unpaired from the telematics system and paired with a camera module, such that pressing the pushbutton or icon now initiates recording by camera module and pressing the pushbutton or icon again stops recording by the camera module. Utilizing BLE and not having dedicated hard-wiring to a telematics module facilitates changing the functionality of a UI interface, such as an icon or push button.

Then present disclosure facilitates communication and interaction between multiple UIs simultaneously provided at different locations of the vehicle 102 and the after-sales applications, the after-market phone applications, and the camera module such that they may be utilized by a different RAT technology or Carrier. Utilizing BLE and the BUB 119 ensure the communication and interaction is maintained if primary vehicle power is disrupted.

The present disclosure facilitates a UI that wirelessly communicates with an ECU by reducing an amount of hard-wired connections that are susceptible to failure, operating in a reduced power mode of a vehicle IGN-off state, providing multiple UIs simultaneously at different locations of a vehicle without changing ECU hardware design, providing an independently-powered ESUI that can initiate a telematics system without requiring the telematics system to be powered, providing fast initiation in an ignition-off state while minimizing power usage, facilitating operation without vehicle battery power using a BUB dedicated to the ECU, operating independently of CAN and Ethernet signals, identifying electrical interface issues and wirelessly communicating an indication of the identified issues, facilitating adapting to the sunset of present communications protocols, facilitating pairing of phone applications to allow the UI to interact wirelessly with other after-sales applications or another telematics device, facilitating determining a location of a user that utilizes a UI that is located outside an area in which a driver of a vehicle is located during operation of the vehicle, wirelessly changing functionality of a UI interface, and facilitating hard-wired control as an alternative to BT/BLE control of the ECU.

The present disclosure addresses challenges faced by present systems by providing a separate BUB to power the ECU, such that the ECU remains powered and can initiate the telematics system even when main power or a hard-wired controlled BUB is not available, with the separate BUB controlled via a non-hard-wired connection, such as BT. Furthermore, the present disclosure facilitates multiple user interfaces around the vehicle that can be utilized by users, who are external the vehicle or not in the area of the vehicle in which the driver is usually located, to initiate a request for service, such as by pressing a pushbutton or icon to initiate a service call, as well as facilitating determining a location of a user that utilizes a UI to request service, such as by determining BT/BLE signal strength. Moreover, the present disclosure allows additional interfaces to be provided without changing the connectivity of the ECU hardware design.

The present disclosure, by utilizing BT/BLE and not having dedicated hard-wired connections to a telematics module, facilitates completely changing the functionality of a UI, such as an icon or pushbutton. The present disclosure maximizes operations of interfaces and enables initiation of services from a UI of organizational change management (OEM) and after-sales applications during a low-power IGN-off operation mode.

All methods disclosed herein may be performed in a suitable order unless otherwise indicated or otherwise clearly contradicted by context. The use of examples, or exemplary language (e.g., “such as”) provided herein, is intended merely to better illuminate the present disclosure and does not pose a limitation on the scope of the present disclosure unless otherwise indicated. No language in the present disclosure should be construed as indicating an unclaimed element as required to the practice of the present disclosure. Accordingly, the present invention includes all modifications and equivalents of the subject matter recited in the claims appended hereto as permitted by applicable law. Moreover, a combination of the previously disclosed elements in possible variations thereof is encompassed by the present disclosure unless otherwise indicated or otherwise clearly contradicted by context.

The present disclosure and the drawings support the appended claims, but the scope of the present disclosure is defined solely by the appended claims. Furthermore, while some of the best modes and other embodiments for carrying out the present disclosure have been disclosed in detail, various alternative designs and embodiments exist for practicing the present disclosure as recited in the appended claims. Moreover, the present disclosure expressly includes combinations and sub-combinations of the elements and features disclosed herein.

Aspects of the present disclosure have been presented in general terms and in detail with reference to the illustrated embodiments. Various modifications may be made by those skilled in the art without departing from the scope and spirit of the disclosed embodiments. One skilled in the relevant art will also recognize that the disclosed methods and supporting hardware implementations may be alternatively embodied in other specific forms without departing from the scope of the present disclosure. Therefore, the present disclosure is intended to be illustrative without limiting the inventive scope defined solely by the appended claims.

What is claimed is:

1. A system for initiating a telematics service call via a touch-based user interface of a vehicle, the system comprising:
a main power unit (MPU) providing power to operate the vehicle and a plurality of vehicle systems;
one or more user interfaces (UI) facilitating a user providing an indication of an event that requires communication with a location external to the vehicle;
a telematics system providing communications related to telematics services;
a communication interface initiating communication between the vehicle and the location external the vehicle in response to receiving the indication of the event;
an Electrical Control Unit (ECU) facilitating communication, in the absence of a serial communications network and ethernet signals, between the one or more UI and the communication interface and between the communication interface and the location external the vehicle;
a first back-up power unit supplying power to ECU;
a second back-up power unit supplying power to the UI such that the UI and ECU remain functional during disruption of power supplied by the MPU; and
a control processor sensing a disruption of power provided by the MPU and activating a low-power operating mode for the UI and ECU when disruption of power provided by the MPU is sensed.

2. The system of claim 1, further comprising a plurality of UI located at various locations of the vehicle, each of the plurality of UI providing an indication of an event that requires communication with the location external the vehicle, wherein:
the communication interface further initiates communication between the vehicle and the location external the vehicle in response to receiving the indication from any of the plurality of UI; and
the ECU further facilitates communication, in the absence of the serial communication interface and the ethernet signals, between each of the plurality of UI and the communication interface.

3. The system of claim 2, wherein at least one of the plurality of UI is located external an area of the vehicle in which a driver of the vehicle is located when the vehicle is in motion.

4. The system of claim 3, wherein the ECU further determines if the indication is received from the at least one of the plurality of UI located external the area of the vehicle in which a driver of the vehicle is located.

5. The system of claim 2, wherein the ECU further facilitates communication between at least one of the plurality of UI and at least one device or software application utilized in the vehicle after purchase.

6. The system of claim 5, wherein the at least one device or software application is related to a camera.

7. The system of claim 1, wherein the location external to the vehicle comprises a call center with at least one operator.

8. The system of claim 1, wherein the ECU comprises a Bluetooth Low Energy (BLE) unit.

9. The system of claim 1, wherein the serial communications network comprises a Controller Area Network (CAN).

10. A system incorporated within a vehicle, the system being configured to initiate a telematics service call via a touch-based user interface, the system comprising:
a main power unit (MPU) providing power to operate the vehicle and a plurality of vehicle systems;
one or more pushbuttons or icons facilitating a user providing an indication of an event that requires communication with a call center with at least one operator;
a telematics system providing communications related to telematics services;
a communication interface initiating communication between the vehicle and the call center in response to receiving the indication of the event;
a Bluetooth Low Energy (BLE) unit providing a BLE user interface (UI) and facilitating communication, in the absence of a Controller Area Network (CAN) and ethernet signals, between the one or more pushbuttons or icons and the communication interface and between the communication interface and the call center;
a first back-up battery (BUB) supplying power to the BLE unit;
a second BUB supplying power to the one or more pushbuttons or icons and the BLE unit such that one or more pushbuttons or icons and the BLE unit remain functional during disruption of power supplied by the MPU; and
a control processor sensing a disruption of power provided by the MPU and activating a low-power operating mode for the one or more pushbuttons or icons and the BLE unit when disruption of power provided by the MPU is sensed.

11. The system of claim 10, further comprising a plurality of pushbuttons or icons located at various locations of the vehicle, each of the plurality of pushbuttons or icons providing an indication of an event that requires communication with the call center, wherein:
the communication interface further initiates communication between the vehicle and the call center in response to receiving the indication from any of the plurality of pushbuttons or icons; and
the BLE unit further facilitates communication, in the absence of the CAN and the ethernet signals, between each of the plurality pushbuttons or icons and the communication interface.

12. The system of claim 11, wherein at least one of the plurality of pushbuttons or icons is located external an area of the vehicle in which a driver of the vehicle is located when the vehicle is in motion.

13. The system of claim 12, wherein the BLE unit further determines if the indication is received from the at least one of the plurality of UI located external the area of the vehicle in which a driver of the vehicle is located.

14. The system of claim 11, wherein the BLE unit further facilitates communication between at least one of the plurality of pushbuttons or icons and at least one device or software application utilized in the vehicle after purchase.

15. The system of claim 14, wherein the at least one device or software application is related to a camera.

16. A motor vehicle comprising:
a vehicle body;
a main power unit (MPU) providing power to operate the vehicle and a plurality of vehicle systems;
one or more user interfaces (UI) facilitating a user providing an indication of an event that requires communication with a location external the vehicle;
a telematics system providing communications related to telematics services;
a communication interface initiating communication between the vehicle and the location external the vehicle in response to receiving the indication of the event;
an Electrical Control Unit (ECU) facilitating communication, in the absence of a serial communications network and ethernet signals, between the one or more UI and the communication interface and between the communication interface and the location external the vehicle;
a first back-up power unit supplying power the ECU;
a second back-up power unit supplying power to the UI such that the UI and ECU remain functional during disruption of power supplied by the MPU; and
a control processor sensing a disruption of power provided by the MPU and activating a low-power operating mode for the UI and ECU when disruption of power provided by the MPU is sensed.

17. The system of claim 16, further comprising a plurality of UI located at various locations of the vehicle, each of the plurality of UI providing an indication of an event that requires communication with the location external the vehicle, wherein:
the communication interface further initiates communication between the vehicle and the location external the vehicle in response to receiving the indication from any of the plurality of UI; and
the ECU further facilitates communication, in the absence of the serial communication interface and the ethernet signals, between each of the plurality of UI and the communication interface.

18. The system of claim 17, wherein at least one of the plurality of UI is located external an area of the vehicle in which a driver of the vehicle is located when the vehicle is in motion.

19. The system of claim 18, wherein the ECU further determines if the indication is received from the at least one of the plurality of UI located external the area of the vehicle in which a driver of the vehicle is located.

20. The system of claim 17, wherein the ECU further facilitates communication between at least one of the plurality of UI and at least one device or software application utilized in the vehicle after purchase.
